(19) United States
(12) Patent Application Publication
(10) Pub. No.: US 2020/0023770 A1
(43) Pub. Date: Jan. 23, 2020

(54) VEHICULAR REMINDER DEVICE

(71) Applicant: Jae Yul Kim, Los Angeles, CA (US)

(72) Inventor: Jae Yul Kim, Los Angeles, CA (US)

(21) Appl. No.: 16/515,077

(22) Filed: Jul. 18, 2019

Related U.S. Application Data
(60) Provisional application No. 62/700,187, filed on Jul. 18, 2018.

(30) Foreign Application Priority Data
Feb. 22, 2019 (KR) 10-2019-0020986

(51) Int. Cl. B60Q 5/00; B60Q 1/00; B60Q 9/00

(52) U.S. Cl. CPC B60Q 5/005; B60Q 9/00; B60Q 1/00

(57) ABSTRACT

Provided is a vehicular reminder device in a system for preventing an object of interest from being left unattended in a vehicle. Drivers including a parent, a grandparent, and a pet owner may simply and conveniently install the system for preventing an object of interest from being left unattended in a vehicle in their vehicles and protect objects of interest, such as a baby, a child, a pet, and a stuff, that they love.

### CROSS-REFERENCE TO RELATED APPLICATION(S)

This application claims priority from U.S. Patent Application No. 62/700,187, filed on Jul. 18, 2018 in the US Intellectual Property Office and Korean Patent Application No. 10-2019-0020986, filed on Feb. 22, 2019, in the Korean Intellectual Property Office, the disclosure of which is incorporated herein by reference in its entirety.

### BACKGROUND

### 1. Field

The following description relates to a system for preventing an object of interest, such as a baby, a child, a pet, or a stuff, from being left unattended in a vehicle and more particularly, to a vehicular reminder device.

### 2. Description of Related Art

Every year, a significant number of babies and children are left unattended to die in cars. Also, a much greater number of babies and children are trapped in emergency situations and injured sometimes. In order to avoid solving such a problematic situation on the basis of laws, it is best to prevent occurrence of such a situation.

These days, considering an increasing trend towards vehicle use in various situations and global warming, it is necessary to develop a technology for preventing a child or a pet from being left unattended in a vehicle. Therefore, the present inventor conducted research on a technology for preventing an object of interest, such as a baby, a child, a pet, or a stuff, from being left unattended in a vehicle.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a system for preventing an object of interest, such as a baby, a child, a pet, or a stuff, from being left unattended in a vehicle.

In one general aspect, a system for preventing an object of interest from being left unattended in a vehicle includes a vehicular reminder device configured to warn people to check whether an object of interest is left unattended in a vehicle. The vehicular reminder device includes a door open sensor configured to sense opening of a driver-side door of the vehicle; a speaker configured to output an alarm for warning people to check whether an object of interest is left unattended in the vehicle when opening of the driver-side door of the vehicle is sensed by the door open sensor; and a controller configured to perform overall device control including alarm output control for warning people to check whether an object of interest is left unattended in the vehicle.

In an additional aspect, the vehicular reminder device may further include a digital recorder configured to record and store alarm data for warning people to check whether an object of interest is left unattended in the vehicle.

In an additional aspect, the door open sensor may be a magnetic sensor configured to sense whether the driver-side door of the vehicle is opened by detecting a change in a magnetic field of a magnet attached to an internal side of the driver-side door of the vehicle.

In an additional aspect, the magnet attached to the internal side of the driver-side door of the vehicle may be formed by connecting a plurality of magnet pieces by a connecting member so as to be readily attached to a curved surface of the internal side of the driver-side door of the vehicle.

In an additional aspect, the vehicular reminder device may further include a button window configured to select playback or recording of the alarm data.

In an additional aspect, the vehicular reminder device may further include a first dual inline package (DIP) switch configured to set an alarm method.

In an additional aspect, the vehicular reminder device may further include a second DIP switch configured to set a type of alarm comment.

Other features and aspects will be apparent from the following detailed description, the drawings, and the claims.

### BRIEF DESCRIPTION OF THE DRAWINGS

FIG. 1 is a block diagram showing a configuration of a vehicular reminder device of a system for preventing an object of interest from being left unattended in a vehicle according to an exemplary embodiment of the present invention.

FIG. 2 is an external perspective view of a vehicular reminder device of a system for preventing an object of interest from being left unattended in a vehicle according to an exemplary embodiment of the present invention.

FIG. 3 shows a dual inline package (DIP) switch installed on an internal printed circuit board (PCB) of a vehicular reminder device of a system for preventing an object of interest from being left unattended in a vehicle according to an exemplary embodiment of the present invention.

FIG. 4 is a block diagram showing an example of a motion sensor installed in a system for preventing an object of interest from being left unattended in a vehicle according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments of the present invention will be described in detail with reference to the accompanying drawings so that those of ordinary skill in the art may easily understand and implement the present invention. Although particular embodiments are shown in the drawings and detailed descriptions thereof are given, these are not intended to limit various embodiments of the present invention to particular forms.

In describing the present invention, a detailed description of a related known function or element will be omitted when it is deemed to make the gist of exemplary embodiments of the present invention unclear.

It will be understood that when an element is referred to as being “connected” or “coupled” to another element, it may be directly connected or coupled to the other element or intervening elements may be present.

In contrast, it will be understood when an element is referred to as being “directly connected” or “directly coupled” to another element, there are no intervening elements present.

A system for preventing an object of interest from being left unattended in a vehicle according to the present invention includes a vehicular reminder device 100 which notifies drivers including a parent, a grandparent, and a pet owner that an object of interest, such as a baby, a child, a pet, and a stuff, is left unattended in a vehicle when the drivers open a vehicle door.

When a driver opens a vehicle door, the vehicular reminder device 100 generates an alarm regardless of whether the engine is on and thereby reminds the driver to check whether an object of interest, such as a baby, a child, a pet, and a stuff, is on a rear car seat. Here, the alarm may include various alarms such as voice alarms, light, and mechanical vibrations.

Meanwhile, the vehicular reminder device 100 may be attached to an internal handle of a driver-side door of a vehicle with a fixing member, such as a double sided tape, and sense whether the driver-side door is opened. However, the vehicular reminder device 100 is not limited thereto and may be disposed or installed under the driver's seat or in a space or gap around the seat.

When the driver opens the driver-side door of the vehicle, the vehicular reminder device 100 senses a door open signal indicating that the driver-side door of the vehicle is opened and generates an alarm indicating that an object of interest, such as a baby, a child, a pet, and a stuff, is left unattended in the vehicle.

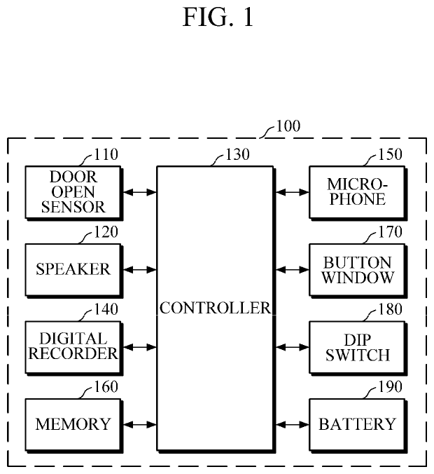

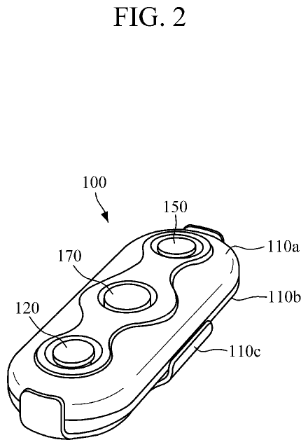

FIG. 1 is a block diagram showing a configuration of a vehicular reminder device of a system for preventing an object of interest from being left unattended in a vehicle according to an exemplary embodiment of the present invention, and FIG. 2 is an external perspective view of a vehicular reminder device of a system for preventing an object of interest from being left unattended in a vehicle according to an exemplary embodiment of the present invention.

The vehicular reminder device 100 according to this embodiment includes an upper case 100a and a lower case 100b which are mechanically combined with each other, and the lower case 100b may be fixed and supported by a cradle 100c.

A rear surface of the cradle 100c is attached to the internal handle of the driver-side door of the vehicle using a fixing member, such as a double sided tape, such that the vehicular reminder device 100 is attached to the internal handle of the driver-side door of the vehicle.

The vehicular reminder device 100 according to this embodiment includes a door open sensor 110, a speaker 120, and a controller 130. The door open sensor 110, the speaker 120, and the controller 130 are mounted on a printed circuit board (PCB) 110d and embedded in the upper case 100a and the lower case 100b which are combined with each other.

The door open sensor 110 senses opening of the driver-side door of the vehicle. For example, the door open sensor 110 may be a magnetic sensor which senses whether the driver-side door of the vehicle is open by detecting a change in a magnetic field of a magnet (not shown) attached to an internal side of the driver-side door of the vehicle. However, the door open sensor 110 is not limited thereto.

Like a metal watch chain, the magnet attached to the internal side of the driver-side door of the vehicle may be formed by connecting a plurality of magnet pieces by a connecting member so as to be readily attached to a curved surface of the internal side of the driver-side door of the vehicle.

The magnet formed by connecting a plurality of magnet pieces by a connecting member is attached to the curved surface of the internal side of the driver-side door of the vehicle, and the vehicular reminder device 100 in which the magnet sensor is embedded is attached to the internal handle of the driver-side door of the vehicle in correspondence to the magnet.

When the driver pulls the internal handle of the driver-side door of the vehicle, the vehicular reminder device 100 is moved together with the handle, and the magnet sensor goes away from the magnet attached to the internal side of the driver-side door of the vehicle, such that a magnetic field is changed. When a change in the magnetic field is detected, the magnet sensor generates a door open signal.

When the door open sensor 110 senses that the driver-side door of the vehicle is opened, the speaker 120 generates an alarm for warning people to check whether an object of interest is left unattended in the vehicle.

The alarm may be a human voice which is repeated for a specific period of time until the driver appropriately recognizes the situation through the warning alarm. For example, the alarm may be a speech of a human voice composed of one or more sentences or words, such as “Don't forget me!”.

The controller 130 performs overall device control including alarm output control for warning people to check whether an object of interest is left unattended in the vehicle. When the door open sensor 110 senses opening of the driver-side door of the vehicle, a door open signal is transferred from the door open sensor 110 to the controller 130.

When the door open signal is received, the controller 130 performs voice signal processing so that the alarm for warning people to check whether an object of interest is left unattended in the vehicle may be output through the speaker 120.

Then, the driver hears the alarm, which is output through the speaker 120 and warns people to check whether an object of interest is left unattended in the vehicle, and checks whether an object of interest is left unattended in the vehicle.

This implementation of the present invention enables drivers including a parent, a grandparent, and a pet owner to simply and conveniently install the vehicular reminder device 100 in their vehicles and to protect objects of interest, such as a baby, a child, a pet, and a stuff, that they love.

Accordingly, it is possible to prevent an object of interest, such as a baby, a child, or a pet, from being left unattended in a vehicle due to carelessness of drivers including a parent, a grandparent, and a pet owner, and prevent death or injury of the baby, child, pet, or the like.

Also, it is possible to induce vehicle manufacturers to essentially install a system for preventing an object of interest from being left unattended in a vehicle according to the present invention in new vehicles in the future in order to protect an object of interest, such as a baby, a child, a pet, or a stuff.

Meanwhile, according to an additional aspect of the present invention, the vehicular reminder device 100 may further include a digital recorder 140. The digital recorder 140 records and stores alarm data for warning people to check whether an object of interest is left unattended in the vehicle.

When recording is selected by a user's operation through a button or the like, the digital recorder 140 receives voice through a microphone 150 and stores the received voice as alarm data for warning people to check whether an object of interest is left unattended in the vehicle.

Alarm data may be recorded by the digital recorder 140 every time an object of interest, such as a baby, a child, a pet, or a stuff, gets on the vehicle, or alarm data which is recorded once may be used later on.

Meanwhile, according to an additional aspect of the present invention, the vehicular reminder device 100 may further include a button window 170. The button window 170 simultaneously operates as an input means for selecting playback or recording of alarm data and an output means for outputting light through a light-emitting diode (LED).

As an example, when the button window 170 is pressed for a long time, a recording mode is selected, and the digital recorder 140 records and stores alarm data for warning people to check whether an object of interest is left unattended in the vehicle.

As another example, when the button window 170 is pressed for a short time, an alarm data playback mode is selected, and an alarm, which corresponds to a currently set type of alarm comment and warns people to check whether an object of interest is left unattended in the vehicle, is output through the speaker 120.

Additionally, as soon as opening of the driver-side door of the vehicle is sensed and the alarm for warning people to check whether an object of interest is left unattended in the vehicle is output, the LED in the button window 170 may be turned on and output light for visual warning.

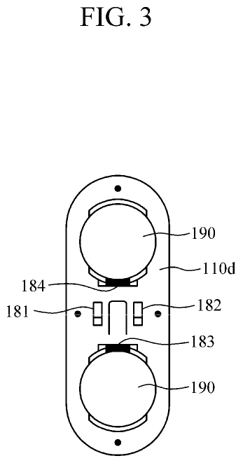

Meanwhile, according to an additional aspect of the present invention, the vehicular reminder device 100 may further include a dual inline package (DIP) switch 180 as shown in FIG. 3. FIG. 3 shows a DIP switch installed on an internal PCB of a vehicular reminder device of a system for preventing an object of interest from being left unattended in a vehicle according to an exemplary embodiment of the present invention.

For example, the DIP switch 180 may include a first DIP switch 181 for setting an alarm method, a second DIP switch 182 for setting a type of alarm comment, a third DIP switch 183 for setting a speaker volume, a fourth DIP switch 184 for setting a microphone volume.

For example, according to a setting of the first DIP switch 181, it is possible to determine how to give the warning, that is, by only outputting voice through the speaker 120, only turning on the LED through the button window 170, or simultaneously outputting voice through the speaker 120 and turning on the LED through the button window 170.

According to a setting of the second DIP switch 182, it is possible to set which one of recorded comments will be output among first, second, third, fourth, etc. recorded comments.

For example, the first recorded comment may be “Check if your child is left in the car,” the second recorded comment may be “Check if your pet is left in the car,” the third recorded comment may be “Check if your stuff is left in the car,” and the fourth recorded comment may be a comment input by a user.

The speaker volume may be set to one of “high,” “medium,” and “low” according to a setting of the third DIP switch 183, and the microphone volume may be set to one of “high,” “medium,” and “low” according to a setting of the fourth DIP switch 184.

Meanwhile, according to an additional aspect of the present invention, the vehicular reminder device 100 may further include at least one battery 190. For example, the battery 190 may be a mercury cell, a nickel battery, or the like but is not limited thereto.

In this case, the circuit may be configured so that the vehicular reminder device 100 may operate only when opening of the driver-side door of the vehicle is sensed. Then, it is possible to reduce power consumption of the battery 190.

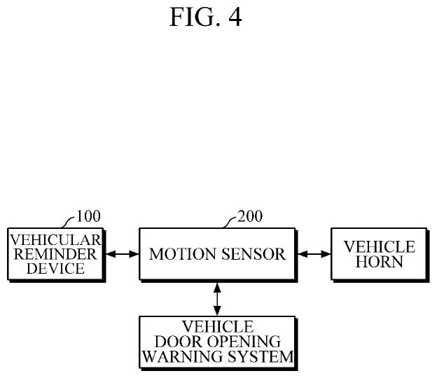

Meanwhile, according to an additional aspect of the present invention, the vehicular reminder device 100 may further include a motion sensor 200 as shown in FIG. 4. FIG. 4 is a block diagram showing an example of a motion sensor installed in a system for preventing an object of interest from being left unattended in a vehicle according to an exemplary embodiment of the present invention.

The motion sensor 200 is installed in a roof or the like of the vehicle and detects motion of an object of interest, such as a baby, a child, or a pet. When opening of the driver-side door of the vehicle is sensed by the door open sensor 110 of the vehicular reminder device 100 or a common vehicle door opening warning system mounted in a vehicle, the motion sensor 200 may be activated to detect motion of an object of interest, such as a baby, a child, or a pet, in the vehicle and notify the driver that an object of interest is in the vehicle through an additional warning alarm which is in the form of audio, video, light, or mechanical vibrations.

For example, the motion sensor 200 may have a communication function therein and provide a notification that an object of interest is in the vehicle to a personal information processing device, such as a smart phone, a smart key, or the like that the driver has via a local or global communication network. However, the motion sensor 200 is not limited thereto and may provide the notification that an object of interest is in the vehicle through a vehicle horn or the like.

If the additional warning alarm is issued through the motion sensor 200, it is possible to notify the driver or people around the vehicle that an object of interest, such as a baby, a child, or a pet, is left unattended in the vehicle even when the vehicular reminder device 100 does not operate due to a malfunction thereof or so on.

As described above, the present invention enables drivers including a parent, a grandparent, and a pet owner to simply and conveniently install a system for preventing an object of interest from being left unattended in a vehicle according to the present invention in their vehicles and to protect objects of interest, such as a baby, a child, a pet, and a stuff, that they love.

Accordingly, it is possible to prevent an object of interest, such as a baby, a child, or a pet, from being left unattended in a vehicle due to a driver's carelessness and prevent death or injury of the baby, child, pet, or the like.

Also, it is possible to induce vehicle manufacturers to essentially install a system for preventing an object of interest from being left unattended in a vehicle according to the present invention in new vehicles in the future in order to protect an object of interest, such as a baby, a child, a pet, or a stuff.

The present invention can be industrially used in vehicle technology fields and application technology fields thereof.

Embodiments disclosed herein and illustrated in the drawings are set forth as specific examples only to help understanding and are not intended to limit the scope of various embodiments of the present invention.

Accordingly, the scope of various embodiments of the present invention should be interpreted to encompass all alterations and modifications derived from the technical spirit of various embodiments of the present invention as well as the above-described embodiments.

1. A vehicular reminder device comprising:
a door open sensor configured to sense opening of a driver-side door of a vehicle;
a speaker configured to output an alarm for warning people to check whether an object of interest is left unattended in the vehicle when opening of the driver-side door of the vehicle is sensed by the door open sensor; and
a controller configured to perform overall device control including alarm output control for warning people to check whether an object of interest is left unattended in the vehicle.

2. The vehicular reminder device of claim 1, further comprising a digital recorder configured to record and store alarm data for warning people to check whether an object of interest is left unattended in the vehicle.

3. The vehicular reminder device of claim 1, wherein the door open sensor is a magnetic sensor configured to sense whether the driver-side door of the vehicle is opened by detecting a change in a magnetic field of a magnet attached to an internal side of the driver-side door of the vehicle.

4. The vehicular reminder device of claim 3, wherein the magnet attached to the internal side of the driver-side door of the vehicle is formed by connecting a plurality of magnet pieces by a connecting member so as to be readily attached to a curved surface of the internal side of the driver-side door of the vehicle.

5. The vehicular reminder device of claim 3, further comprising a button window configured to select playback or recording of the alarm data.

6. The vehicular reminder device of claim 5, further comprising a first dual inline package (DIP) switch configured to set an alarm method.

7. The vehicular reminder device of claim 5, further comprising a second dual inline package (DIP) switch configured to set a type of alarm comment.

8. The vehicular reminder device of claim 2, wherein the door open sensor is a magnetic sensor configured to sense whether the driver-side door of the vehicle is opened by detecting a change in a magnetic field of a magnet attached to an internal side of the driver-side door of the vehicle.
